(19) United States
(12) Patent Application Publication
(10) Pub. No.: US 2006/0292428 A1
(43) Pub. Date: Dec. 28, 2006

(54) Fuel cell system with sealed fuel cell stack and method of making the same

(76) Inventor: Dong Myung Suh, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/474,030

(22) Filed: Jun. 23, 2006

(30) Foreign Application Priority Data
Jun. 24, 2005 (KR) 10-2005-55296

(51) Int. Cl. H01M 2/08; H01M 8/10; H01M 8/04; H01M 8/02; B05D 5/12

(52) U.S. Cl. 429/35; 429/30; 429/26; 429/38; 427/115

(57) ABSTRACT

Disclosed is a fuel cell system including a fuel cell stack. The fuel cell stack includes a plurality of unit cells stacked together. The unit cell includes an electrolyte membrane, a separator and a gasket, which is located between the separator and the electrolyte membrane and provide sealing therebetween. Further, the fuel cell stack is coated with a coating over at least part of the exterior surfaces of the fuel cell stack. The coating provides additional sealing, which prevents any leakage from occurring in the fuel cell stack.

### CROSS-REFERENCE TO RELATED APPLICATIONS

This application claims the benefit of Korean Patent Application No. 2005-55296, filed on Jun. 24, 2005, which is incorporated herein by reference in its entirety.

### BACKGROUND

1. Field

The present invention relates to a fuel cell system, and more particularly to sealing of a fuel cell stack for the fuel cell system.

2. Discussion of Related Technology

In general, a fuel cell system generates electric energy through an electrochemical reaction between hydrogen gas and oxygen gas. Typically, hydrogen is produced from a hydrogen containing fuel that includes an alcoholic fuel, hydrocarboneous fuel, natural gas fuel, etc. The alcoholic fuel includes, for example, methanol, ethanol, propanol, butanol, etc. The hydro-carbonaceous fuel includes, for example, methane, propane, butane, gasoline, diesel fuel, corn oil, biodiesel fuel, etc. The natural gas fuel includes, for example, liquefied natural gas, etc. The fuel cell system has been researched and developed as an alternative to secure a power source in response to the increased demand for power, particularly clean power.

The fuel cell system is classified into a phosphoric acid fuel cell (PAFC), a molten carbon fuel cell (MCFC), a solid oxide fuel cell (SOFC), a polymer electrolyte membrane fuel cell (PEMFC), an alkaline fuel cell (AFC), etc. based on the fuel, catalyst, electrolyte and the like. Regardless, these different types of the fuel cell systems are generally operated by the same principle. The fuel cell system can be used in various fields requiring electricity, such as mobile devices, transportation, distributed power sources, etc.

Each of such fuel cell systems typically includes a stack of fuel cells, in which unit fuel cells (or unit cells) are stacked together and generate electricity. In a typical fuel cell stack, a plurality of unit cells is stacked between two end plates, which are coupled by bolts and nuts. Each unit cell includes a membrane electrolyte assembly (MEA) and a pair of separators. The MEA includes an electrolyte membrane and two electrodes on both sides of the electrolyte membrane. The separator separates each MEA from the neighboring MEAs by being placed on both sides of each MEA. Thus, the MEAs and separators are altematingly arranged in the fuel cell stack. The separators have channels to flow reactants and resultants of the fuel cell reactions therethrough.

FIG. 10 illustrates an arrangement of an MEA 40 and two separators 80, 90 as if they are in a fuel cell stack. The peripheral areas of the separators 80, 90 are coated with a sealing material S, which contacts the peripheral area of the MEA 40 to prevent fluid from leaking through the gap between the MEA 40 and the separators 80, 90. However, in this sealing scheme, the periphery of the separators has to be individually coated with the sealing material and then assembled together, which requires a lot of processing. Further, it is possible that some leakage can still occur between the MEA 40 and separators 80, 90 depending upon the condition of the sealing.

The foregoing discussion is to provide general background involving the invention disclosed in this application and does not constitute an admission of prior art.

### SUMMARY OF THE INVENTION

One aspect of the invention provides a fuel cell system comprising a fuel cell stack. The fuel cell stack comprises: a pair of end plates; a unit cell assembly comprising a plurality of plate-like structures stacked between the end plates, each plate-like structure comprising an edge and a side surface extending from the edge, the side surfaces of the plate-like structures forming an aggregated surface, which comprises a plurality of interfacial lines, each interfacial line being formed by the edges of two contacting plate-like structures; and a coating formed over at least a portion of the aggregated surface, wherein the coating covers at least a portion of both the side surfaces of two contacting plate-like structures.

In the foregoing system, the coating may comprise at least one of a polyamid resin and a polyolefin resin. The plate-like structures may comprise an electrolyte membrane, a separator and a gasket. The plate-like structures may be stacked such that the gasket is placed between the electrolyte membrane and the separator. The interfacial lines may be formed between the electrolyte membrane and the gasket, or between the gasket and the separator. The coating may cover a portion of the side surface of at least one of the electrolyte membrane and the gasket. The coating may cover a portion of the side surface of the separator. The separator may comprise a coolant channel for a liquid coolant to pass therethrough. The end plates may comprise a coolant supplying pipe and a coolant discharging pipe, wherein the unit cell assembly may comprise a coolant supplying manifold and a coolant discharging manifold, which may be connected to the coolant supplying and discharging pipes, and wherein the coolant channel is connected to the coolant supplying and discharging manifolds.

In the foregoing system, the separator may comprise an air channel for air to pass therethrough. The side surface of the separator may comprise an opening in fluid communication with the air channel, and wherein the coating does not substantially block the opening. The system may further comprise an air manifold placed over at least a portion of the aggregated surface comprising the opening. The coating may not be formed on the portion of the aggregated surface over which the air manifold is placed. The coating may cover at least a portion of an exterior surface of the air manifold. The coating may extend substantially throughout the aggregated surface covering most of the interfacial lines formed on the aggregated surface. The coating may contact the end plates. Each plate-like structure may comprise a second edge and a second side surface extending from the second edge, the second side surfaces of the plate-like structures forming a second aggregated surface, which may comprise a plurality of second interfacial lines, each of which is formed by the second edges of two contacting plate-like structures.

Another aspect of the invention provides a method of making a fuel cell system. The method comprises: providing a unit cell assembly comprising a plurality of plate-like structures stacked between two end plates, each plate-like structure comprising an edge and a side surface extending from the edge, the side surfaces of the plate-like structures forming an aggregated surface, which comprises a plurality of interfacial lines, each interfacial line being formed by the edges of two contacting plate-like structures; and coating a over at least a portion of the aggregated surface, wherein the coating covers at least a portion of both the side surfaces of two contacting plate-like structures, thereby making the fuel cell stack.

Another aspect of the invention provides a fuel cell system comprising a fuel cell stack. The fuel cell stack comprises: two end plates; a plurality of electrolyte membranes, each electrolyte membranes comprises an edge, a peripheral surface extending from the edge, and a side surface extending from the edge away from the peripheral surface; a plurality of separators, each separator comprises an edge, a peripheral surface extending from the edge, and a side surface extending from the edge away from the peripheral surface; and a plurality of gaskets, each gasket comprises an edge and a side surface extending from the edge. The plurality of electrolyte membranes, separators and gaskets are stacked together between the two end plates so as to form a unit cell assembly, wherein one of the gasket is placed between and contacts the peripheral surfaces of one of the electrolyte membranes and one of the separators.

In the foregoing system, the side surfaces of the plurality of electrolyte membranes, separators and gaskets may form an aggregated surface comprising a plurality of interfacial lines, each interfacial line being formed by two neighboring edges of the membranes, separators and gaskets, and wherein the stack may further comprise a coating formed over at least a portion of the aggregated surface. The coating may comprise at least one of a polyamid resin and a polyolefin resin. The coating may extend substantially throughout the aggregated surface covering most of the interfacial lines formed on the aggregated surface. The peripheral surfaces of the electrolyte membranes may be substantially free of a sealing material. The peripheral surfaces of the separator may be substantially free of a sealing material. The gasket may comprise a surface contacting the peripheral surface of one of the electrolyte membranes or the peripheral surface of one of the separators, wherein the surface of the gasket may be substantially free of a sealing material. Each separator may comprise a cooling mechanism configured to cool the unit cell assembly.

A further aspect of the invention provides a method of making a fuel cell system comprising a fuel cell stack. The method comprises providing two end plates; providing a plurality of electrolyte membranes, each electrolyte membranes comprises an edge, a peripheral surface extending from the edge, and a side surface extending from the edge away from the peripheral surface; providing a plurality of separators, each separator comprises an edge, a peripheral surface extending from the edge, and a side surface extending from the edge away from the peripheral surface; providing a plurality of gaskets, each gasket comprises an edge and a side surface extending from the edge; and stacking the plurality of electrolyte membranes, separators and gaskets together between the two end plates so as to form a unit cell assembly, wherein one of the gasket is placed between the peripheral surfaces of one of the electrolyte membranes and one of the separators, thereby making the fuel cell stack.

Accordingly, one aspect of the present invention provides a sealing type stack for a fuel cell system, in which a plurality of unit cells are stacked and its sides exposed between end plates are sealed with a sealing resin, thereby improving a sealing effect.

In an exemplary embodiment of the present invention, a sealing type stack for a fuel cell system includes: a pair of end plates; a unit cell assembly comprising a plurality of unit cells stacked between the end plates; and a resin film surrounding an external surface of the unit cell assembly exposed between the end plates.

In an embodiment of the invention, the unit cell comprises an electrolyte membrane provided with electrodes on opposite surfaces thereof, a separator placed at opposite sides of the electrolyte membrane, and a gasket interposed between the electrolyte membrane and the separator. Further, the end plates are provided with a coolant supplying pipe and a coolant discharging pipe, respectively. Also, the unit cell assembly comprises a coolant supplying manifold and a coolant discharging manifold, which are connected to and communicate with the coolant supplying pipe and the coolant discharging pipe. Here, the unit cell assembly comprises a coolant channel that connects the coolant supplying manifold and the coolant discharging manifold to communicate with each other.

In another exemplary embodiment of the present invention, a sealing type stack for a fuel cell system, includes: a pair of end plates; a unit cell assembly comprising a plurality of unit cells stacked between the end plates; and a resin film surrounding an external surface of the unit cell assembly exposed between the end plates, wherein the unit cell assembly comprises an air channel through which air passes and flows.

In an embodiment of the invention, the sealing type stack further comprises an air inlet manifold placed in an inlet side of the air channel and guiding air to be inhaled, and an air outlet manifold placed in an outlet side of the air channel and guiding air to be discharged. Here, the air inlet manifold is a housing that comprises an opening placed on a bottom portion thereof and facing the inlet of the air channel, and an inlet pipe placed on a top portion thereof and communicating with the opening to inhale air. Further, the air outlet manifold is a housing that comprises an opening placed on a top portion thereof and facing the outlet of the air channel, and an outlet pipe placed on a bottom portion thereof and communicating with the opening to discharge air.

In an embodiment of the invention, the resin film surrounds the external surface of the air outlet manifold in the state that the outlet pipe is exposed to the outside.

### BRIEF DESCRIPTION OF THE DRAWINGS

These and other features and advantages of the invention will become apparent and more readily appreciated from the following description of the embodiments, taken in conjunction with the accompanying drawings of which:

FIG. 1 is an exploded perspective view of a fuel cell stack used in an embodiment of the invention;

FIG. 2A is a perspective view of an assembled fuel cell stack used in an embodiment of the invention;

FIG. 2B is a side view of the assembled fuel cell stack of FIG. 2A;

FIG. 3A is a perspective view of a sealed fuel cell stack according to an embodiment of the present invention;

FIG. 3B is a side view of the sealed fuel cell stack of FIG. 3A;

FIG. 4 is a sectional view of the sealed fuel cell stack, taken along the line IV-IV of FIG. 3B;

FIG. 5 is a perspective view of another fuel cell stack used in an embodiment of the invention;

FIG. 6 is a perspective view of a sealed configuration of the fuel cell stack of FIG. 5 according to an embodiment of the present invention;

FIG. 7 is an exploded perspective view of another fuel cell stack with an air manifold used in an embodiment of the invention;

FIG. 8 is a perspective view of a sealed configuration of the fuel cell stack of FIG. 7 according to another embodiment of the present invention;

FIG. 9 is a sectional view of the air manifold of FIG. 7; and

FIG. 10 is a partial view of a fuel cell stack with a sealing on a periphery of separators.

### DETAILED DESCRIPTION OF EMBODIMENTS

Hereinafter, various features of the present invention will be described in terms of several embodiments. The features of the invention are not limited to the particular forms of the embodiment.

The term “fuel cell stack” or “stack” refers to a number of fuel cells or units forming a fuel cell that are staked together. The stack is an electricity generator that generates electricity by one or more electrochemical reactions in individual or unit fuel cells. Typically, the fuel cell involves the electrochemical reaction between hydrogen and an oxidizing agent, which is well known in the art. In general, the stacks are classified into two different types based on the coolant used to remove heat generated from the operation of the fuel cells. One type is a water-cooled stack, which uses a water- or liquid-based coolant; and the other is an air-cooled stack, which uses air or a gas phase coolant for removing the heat.

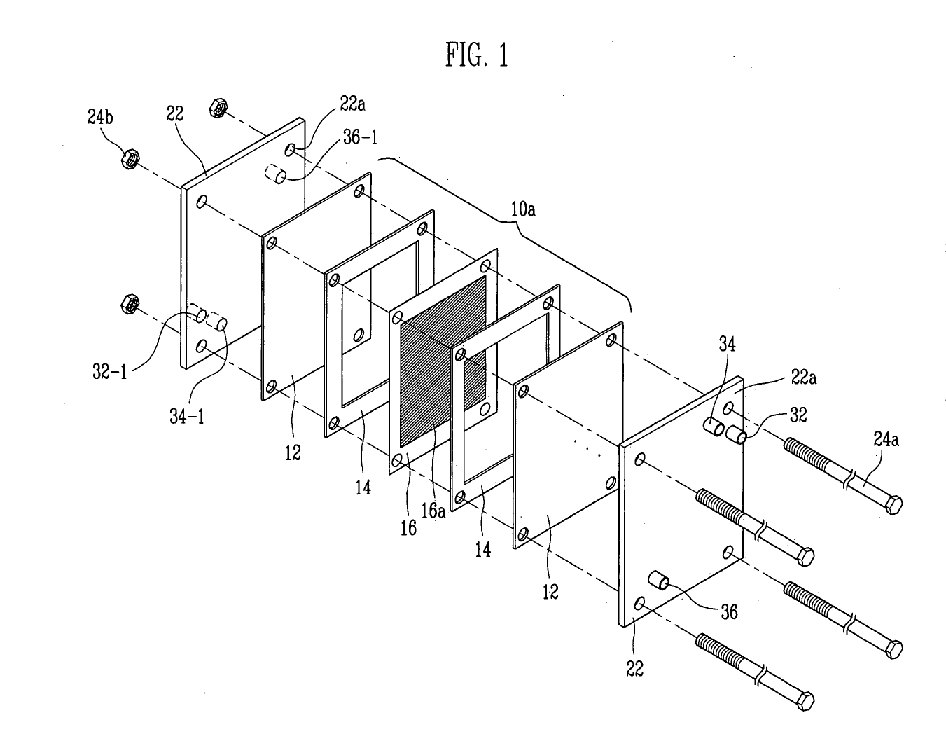

FIG. 1 illustrates an exemplary water-cooled stack according to an embodiment. The stack includes a pair of end plates 22 with a plurality of through holes 22a, and a plurality of unit fuel cells interposed between the end plates 22. For the sake of convenience, in FIG. 1 only one unit cell 10a is illustrated between the end plates 22. The plurality of unit cells 10a which are stacked together will be referred to as a unit cell assembly 10.

The illustrated unit cell 10a includes an electrolyte membrane 16, two separators 12, and two gaskets 14. On both sides of the electrolyte membrane 16, two electrodes 16a (cathode and anode) are formed, although only one side is shown in FIG. 1. As discussed above, the electrolyte membrane and the two electrodes form a membrane electrolyte assembly (MEA). The two separators 12 are placed on the opposite sides of the electrolyte membrane 16. The separator separates each MEA from the neighboring MEAs by being placed on both sides of each MEA. Each of the two gaskets 14 is interposed between the electrolyte membrane 16 and each of the two separators 12.

The right end plate 22 includes an oxidizing agent supplying pipe 34 for supplying the oxidizing agent such as oxygen gas or air to the unit cell assembly 10, and the left end plate 22 includes an oxidizing agent discharging pipe 34-1 for discharging the oxidizing agent from the unit cell assembly 10. The right end plate 22 includes a fuel supplying pipe 36 to supply fuel such as hydrogen containing fuel or hydrogen to the unit cell assembly, and the left end plate 22 has an unreacted fuel discharging pipe 36-1 to discharge unreacted fuel from the unit cell assembly.

The unit cell assembly 10 is provided with an oxidizing agent supplying manifold (not shown) and an oxidizing agent discharging manifold (not shown), which are connected to and communicate with the oxidizing agent supplying pipe 34 and the oxidizing agent discharging pipe 34-1. The separator 12 of the unit cell 10a includes a first surface, which is the surface facing a cathode electrode. The first surface has one or more openings (not shown) connected to an oxidizing agent flowing channel (not shown), which is connected to the oxidizing agent supplying manifold and the oxidizing agent discharging manifold.

The unit cell assembly 10 includes a fuel supplying manifold (not shown) and a fuel discharging manifold (not shown), which are connected to and communicate with the fuel supplying pipe 36 and the fuel discharging pipe 36-1. The separator 12 of the unit cell 10a includes a second surface, which is the surface facing an anode electrode. The second surface has one or more openings (not shown) connected to a fuel flowing channel (not shown), which is also connected to the fuel supplying manifold and the fuel discharging manifold.

The unit cell 10a, hence the unit cell assembly 10, generates heat while operating. Thus, the fuel cell stack includes a cooling mechanism to remove heat from the stack and optimize the operating condition of the stack. The cooling mechanism includes a coolant supplying pipe 32 and a coolant discharging pipe 32-1, which are provided in the respective end plates 22. The coolant supplying pipe 32 is to supply a liquid-based coolant to the unit cell assembly 10, and the coolant discharging pipe 32-1 is to discharge the coolant from the unit cell assembly 10. Accordingly, the unit cell assembly 10 includes a coolant supplying manifold (not shown) and a coolant discharging manifold (not shown), which are connected to and communicate with the coolant supplying pipe 32 and the coolant discharging pipe 32-1. The separator 12 includes a coolant channel (not shown), through which the coolant supplying manifold and the coolant discharging manifold are connected to and communicate with each other. The thickness of the separator may vary among actual embodiments in view of many design factors including the configuration of the coolant channel.

In operation, the oxidizing agent supplied through the oxidizing agent supplying pipe 34 passes through the oxidizing agent supplying manifold, and flows along an oxidizing agent channel to the unit cell 10a. The oxidizing agent participates in a reaction at the cathode electrode of the unit cell 10a. Here, an excessive amount of the oxidizing agent and the resulting products of the cathode reaction are discharged to the outside via the oxidizing agent discharging pipe 34-1 after passing through the oxidizing agent discharging manifold. Likewise, the fuel supplied through the fuel supplying pipe 36 passes through the fuel supplying manifold and flows along a fuel channel to the unit cell 10a. The fuel participates in a reaction at the anode electrode of the unit cell 10a. Here, the unreacted fuel and the resulting products of the anode reaction are discharged to the outside via the fuel discharging pipe 36-1 after passing through the fuel discharging manifold.

The heat generated in the foregoing reactions is transferred to the coolant flowing through the coolant channel supplied through the coolant supplying pipe 32 and the coolant supplying manifold (not shown). Then, the coolant absorbing the heat is discharged to the outside via the coolant discharging pipe 32-1 after passing through the coolant discharging manifold. Although not illustrated, one or both of the end plates 22 includes a port for electrically conductive wiring(s), through which the electricity generated from the unit cell assembly 10 is delivered to the outside.

The gasket 14 has a structure shaped and sized to contact the peripheral areas of the electrolyte membrane 16 and the separator 12. The gasket 14 has a center opening where the electrodes 16a of the electrolyte membrane 16 are exposed. When the stack is assembled, the gasket 14 will liquid- and air-tightly contact the peripheral surfaces of the separator 12 and the electrolyte membrane 16 to prevent any leakage of liquid or gas from the inside of the unit cell 10a to the outside. The gasket 14 is made of a number of different materials that can provide liquid- and air-tight contact with another surface, including plastics, metals, alloys, and composite materials. Skilled artisan will be able to choose appropriate materials for the gasket.

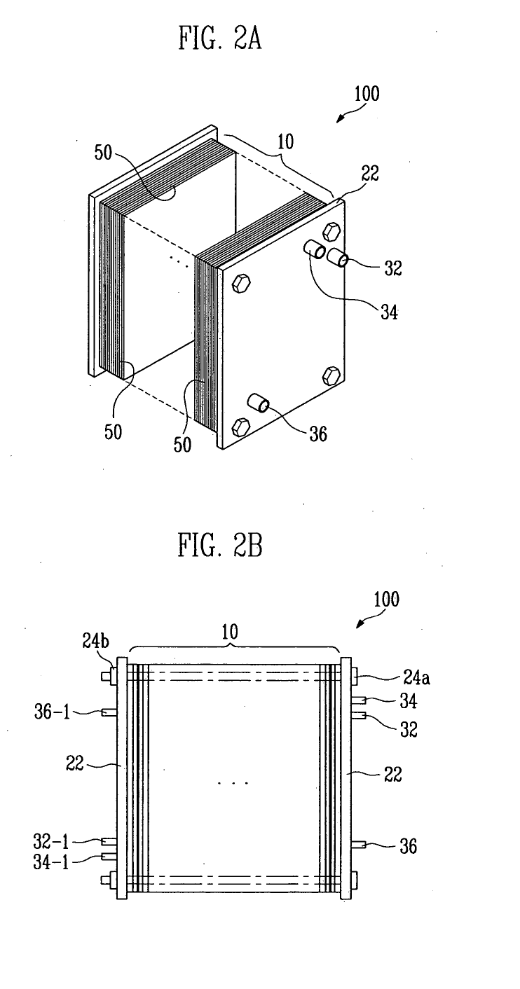

FIGS. 2A and 2B illustrate the assembled stack 100, where a number of unit cells are stacked together in a unit cell assembly 10 between the two end plates 22. The unit cell assembly 10 and the two end plates 22 are put together using a bolt 24a inserted into the through hole 22a (FIG. 1) and a nut 24b. In this assembled stack 100, each gasket 14 is compressed by the separator 12 and the electrolyte membrane 16, thereby preventing any fluid from leaking.

Referring to FIG. 2A, the unit cell assembly 10 has surfaces formed by edges and thin side surfaces of the separators 12, gaskets 14 and electrolyte membranes 16. As illustrated, these surfaces of the unit cell assembly 10 includes a number of interfacial lines 50 formed by two contacting plates including the electrolyte membranes 16, separators 12, gaskets 14 and the end plates 22. The interfacial lines 50 can be formed between an electrolyte membrane 16 and a gasket 14, between a gasket 14 and a separator 12, between a separator 12 and an end plate 22, or between a gasket and an end plate 22. Although the gasket 14 primarily prevents any fluid leaking from the stacked unit cell assembly 10, leaking is possible through these interfacial lines 50. In certain embodiments, the gaskets 14 may be omitted, and the interfacial lines 50 are formed between an electrolyte membrane 16 and a separator 12, between an electrolyte membrane 16 and an end plate 22 or between a separator 12 and an end plate 22.

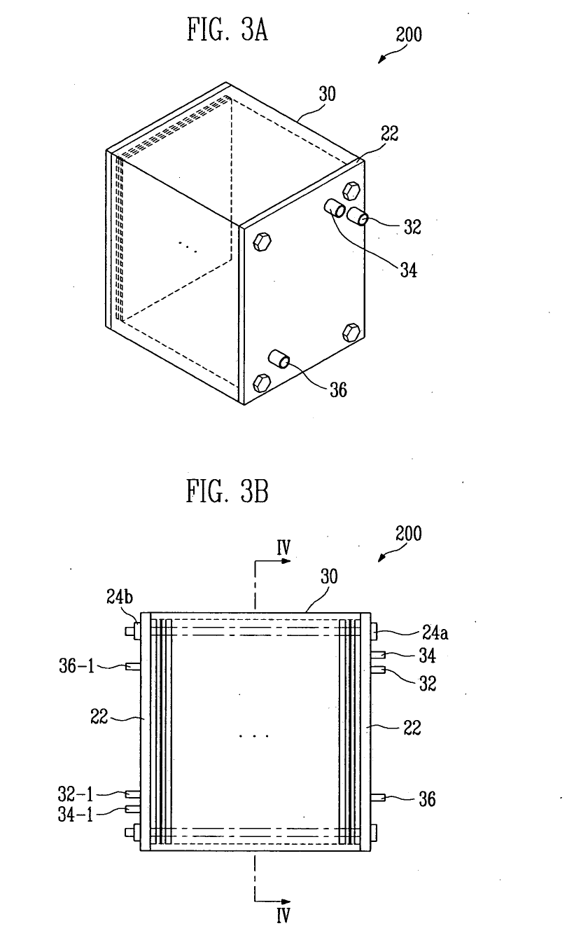

FIGS. 3A and 3B illustrates a sealed or coated stack 200, in which a coating 30 is provided over the exterior surfaces of the unit cell assembly 10 of the stack 100 with or without a gasket. In the stack 100 with the gasket, the coating 30 is formed over the surfaces of the unit cell assembly 10, which are formed by the edges and thin side surfaces of the separators 12, gaskets 14 and electrolyte membranes 16. The coating 30 covers the interfacial lines 50 between two contacting plates of the unit cell assembly 10. Also, the material of the coating 30 can fill in any irregular dents, grooves, defects, gaps or cracks formed in or along the interfacial lines 50 between the two contacting plates. However, the coating 30 may not extend into the area between the opposing surfaces of two neighboring plates. Notwithstanding, as the coating 30 fills in and covers any potentially leakable portions, leakage of any fluid through the interfacial lines 50 much less likely in the sealed stack 200.

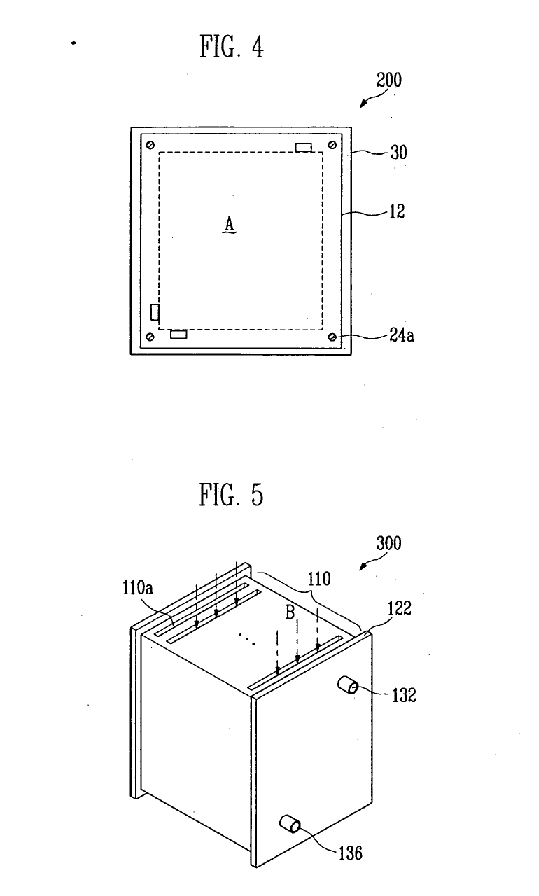

FIG. 4 is a sectional view of the sealed fuel cell stack 200, which shows the coating 30 contacts four edges of the separator 12. Referring back to FIGS. 3A and 3B, the coating 30 is formed throughout the exposed surfaces of the unit cell assembly 10 between the end plates 22 in FIGS. 2A and 2B. In other embodiments, the coating 30 may be formed only over a portion of the exposed surfaces of the unit cell assembly 10. For example, the coating 30 may be formed only along the edges of the separators 12, gaskets 14 and electrolyte membranes 16, where fluid leakage can occur. Although not illustrated, the coating 30 may extend over at least some portion of the end plates 22 too. Although not illustrated, the coating 30 may be a single layer or may include two or more layers of the same or different materials.

In embodiments, the coating 30 is formed of a liquid- and/or air-tight material. In some embodiments, the coating 30 may be formed of a polymeric resin. For example, the polymeric resin includes one or more of a polyamid resin, a polyolefin resin, acrylic resin, epoxy resin, acrylonitrile butadiene styrene copolymer resin, etc. One or more other materials and additives can be added to the polymeric resin to provide various functions, including boning on the surfaces of the unit cell assembly 10.

In one embodiment, the coating 30 can be formed by applying a coating material or mix in liquid or fluid phase over the surfaces where the coating 30 is desired and solidifying the coating material or mix. For example, the coating material may be applied onto the surfaces by spraying. In another embodiment, the coating 30 may be formed by molding or casting. For example, the unsealed stack 100 of FIGS. 2A and 2B is placed in a mold (not shown), which defines a space or cavity to receive the unsealed stack. Then, a coating material in liquid or fluid phase, e.g., a polyamid or polyolefin resin, is supplied into the cavity of the mold, for example, through an injection groove formed in the mold. The coating material supplied into the cavity surrounds and contacts at least part of the external surfaces of the unit cell assembly 10 of the stack. Then, the mold is left being cooled or heated so as to solidify the coating material. Once the coating 30 is formed, the mold is removed, and the stack sealed with the coating 30, i.e., the sealed stack 200 is obtained.

Meanwhile, FIG. 5 illustrates an air-cooled stack 300. In the air-cooled stack 300 compared to the water-cooled stack 100 (FIGS. 2A and 2B), an air channel 110a instead of the coolant channel is provided in the unit cell assembly 110. The air-cooled stack 300 includes one end plate 122 provided with an oxidizing agent supplying pipe 132 and a fuel supplying pipe 136, and the other end plate 122 provided with oxidizing agent discharging pipe (not shown) and a fuel discharging pipe (not shown). As compared with the water-cooled stack, the air-cooled stack 300 does not include the coolant supplying pipe nor the coolant discharging pipe. Likewise, the unit cell assembly 110 includes an oxidizing agent supplying manifold, an oxidizing agent discharging manifold, a fuel supplying manifold, and a fuel discharging manifold, all of which are not shown. The separator (not shown) of the air-cooled stack 300 includes an oxidizing agent channel and a fuel channel. As compared with the water-cooled stack, however, the air-cooled stack 300 includes none of the coolant supplying manifold, the coolant discharging manifold and the coolant channel. However, in certain embodiments, the air-cooled stack may includes air passageways equivalent to at least one of the coolant supplying manifold, the coolant discharging manifold and the coolant channel.

The air channels 110a of the air-cooled stack 300 include one or more air inlets for inhaling air and an outlet. In FIG. 5, the inlets are shown as elongated slots arranged in parallel on the top surface of the unit cell assemble 110. The outlets are not shown in FIG. 5, but can be similarly formed on the bottom surface of the unit cell assembly 110. In some embodiments, the air channels 110a may be formed in the separators, and the inlets and outlets are elongated in a direction along the arrangement of the separators in the unit cell assembly 110. As in the illustrated embodiment, air flows into the inlet through the air channel 110a formed in the separators to the outlet in the general direction “B” as indicated in FIG. 5. The thickness of the separator may vary among actual embodiments in view of many design factors including the configuration of the air channel 110a. In the air-cooled stack 300, the heat generated from the unit cell assembly 110 is removed by air flowing through the air channel 110a. In certain embodiments, a blower or a fan may blow air toward the inlets of the air channel 110 so as to improve the efficiency of cooling the stack 300.

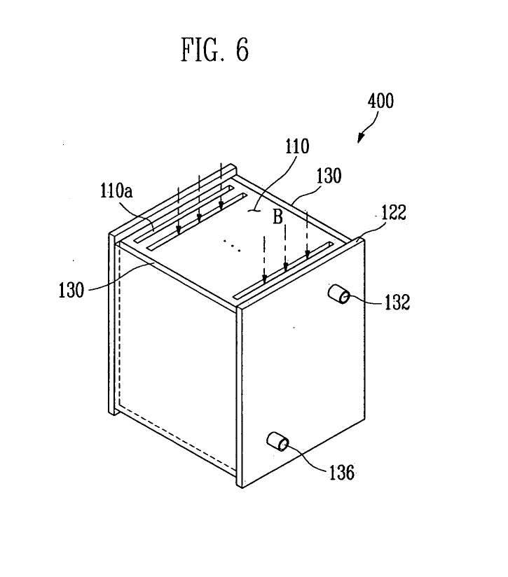

According to an embodiment of the present invention, FIG. 6 illustrates a sealed air-cooled stack 400, in which a coating 130 is formed on the external surfaces of the unit cell assembly 110, except for the inlets and outlets of the air channels 110a. The coating 130 can be formed by any methods applicable, including the methods described above, while not filling the coating material into the air channel 110a. To prevent coating materials are filling into the channel 110a, for example, the inlet and outlet openings may be filled with a plug during the application of the coating materials. Further, for example, the mold for molding may include such a plug. As noted, the air channels 110a including the inlets and outlets are open and flow air to cool the stack 300 during the operation.

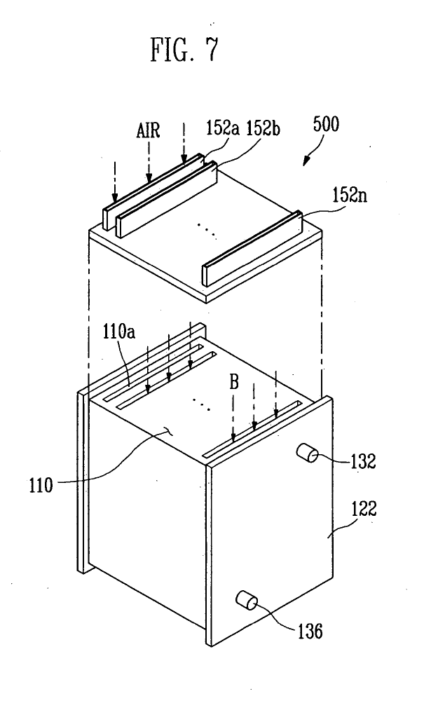

According to another embodiment, FIG. 7 illustrates another air-cooled stack 500 including an air inlet manifold 150, which will prevent the inlets of the air channel from being filled with the coating material while forming the coating. In another embodiment, the air-cooled stack may further include an air outlet manifold (see FIG. 9) similar to the air inlet manifold 150. The air inlet or outlet manifold 150 also guide the air passage to the inlets and from the outlets.

The air inlet manifold 150 includes a housing having inlet pipes 152a-152n formed with a bottom opening facing the inlets of the air channels 110a. Referring to FIG. 9, the air entering the inlet pipes 152a-152n flows to the bottom opening, where the air is distributed to the plurality of inlets. Likewise, the air outlet manifold includes a housing having outlet pipes formed with a top opening facing the outlets of the air channels 110a. As such, the air passing through the air channels 110a in the unit cell assembly 110 is discharged to the top opening, and is distributed among and discharged through the outlet pipes. Although, the air inlet manifold 150 and the air outlet manifold are similarly illustrated in FIG. 9, they may have different configurations. As will be appreciated by skilled artisans, the numbers of the inlet and outlet pipes are not limited to those illustrated.

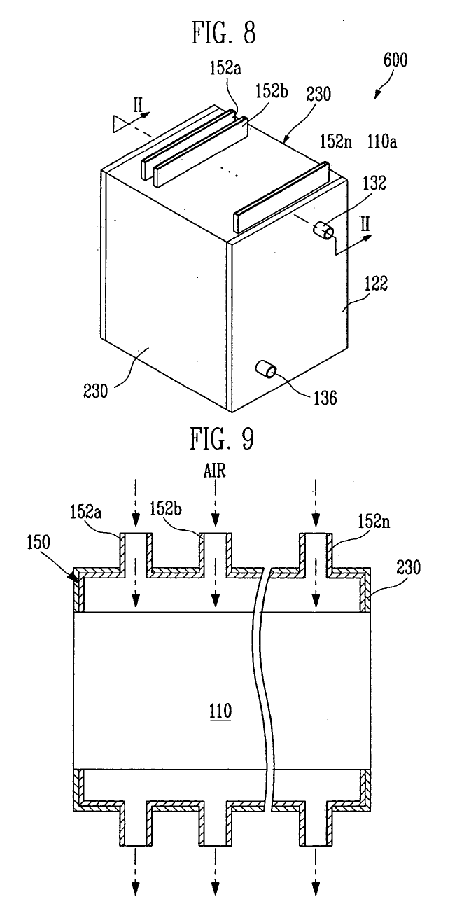

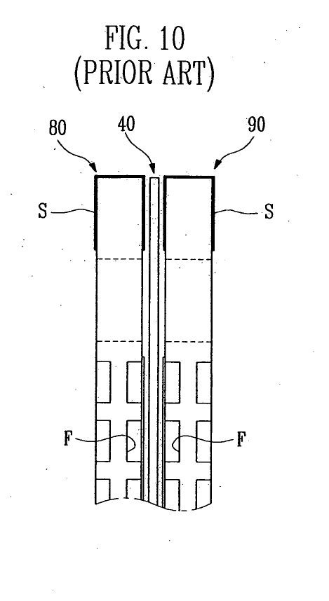

Referring to FIG. 8, a sealed air-cooled stack 600 includes a coating 230 over he external surfaces of the unit cell assembly 110. The coating 230 extends over the air inlet manifold 150 placed over the inlets of the air channels 110a. Although not illustrated, the coating 230 extends over the air outlet manifold placed under the outlets of the air channels 110a. Again, the coating 230 can be formed by any methods applicable, including the methods described above in connection with other embodiments.

As shown in FIG. 9, the coating 230 is formed over at least part of the exterior surface of the air inlet and outlet manifolds. The coating on these inlet and outlet manifolds are integral with the coating formed on the external surface of the unit cell assembly 110 exposed between the end plates 122. Although not limited thereto, in the illustrated embodiment, the exterior surfaces of the inlet and outlet pipes 152a-52n of the air inlet manifold 150 are not coated with the coating 230. Although not illustrated, in other embodiments, the exterior surface of the air inlet or outlet manifold 150 may not be coated with the coating 230 at all.

According to various embodiments of the present invention, the fluid leakage from the stack can be firstly prevented by the gasket and secondly prevented by the coating formed on the exterior surfaces of the unit cell assembly of the fuel cell stack. As such the sealing of the stack is improved, thereby enhancing the stability and safety of the stack.

Although a few embodiments of the present invention have been shown and described, skilled artisans in the art will appreciate that changes might be made in these embodiments without departing from the principles and spirit of the invention, the scope of which is defined in the claims and their equivalents.

What is claimed is:

1. A fuel cell system comprising a fuel cell stack, wherein the fuel cell stack comprises:
a pair of end plates;
a unit cell assembly comprising a plurality of plate-like structures stacked between the end plates, each plate-like structure comprising an edge and a side surface extending from the edge, the side surfaces of the plate-like structures forming an aggregated surface, which comprises a plurality of interfacial lines, each interfacial line being formed by the edges of two contacting plate-like structures; and
a coating formed over at least a portion of the aggregated surface, wherein the coating covers at least a portion of both the side surfaces of two contacting plate-like structures.

2. The system of claim 1, wherein the coating comprises a resin film.

3. The system of claim 2, wherein the material of the resin film comprises at least one of a polyamid resin, a polyolefin resin, acrylic resin, epoxy resin, and acrylonitrile butadiene styrene copolymer resin.

4. The system of claim 1, wherein the plate-like structures comprises at least one unit cell comprising a membrane electrolyte assembly (MEA) and a pair of separators.

5. The system of claim 4, wherein the interfacial lines are formed between the MEA and the separator.

6. The system of claim 4, wherein the plate-like structures further comprises a gasket.

7. The system of claim 6, wherein the plate-like structures are stacked such that the gasket is placed between the MEA and the separator.

8. The system of claim 7, wherein the separator comprises a coolant channel for a liquid coolant to pass therethrough.

9. The system claim 8, wherein the end plates comprises a coolant supplying pipe and a coolant discharging pipe, wherein the unit cell assembly comprises a coolant supplying manifold and a coolant discharging manifold, which are connected to the coolant supplying and discharging pipes, and wherein the coolant channel is connected to the coolant supplying and discharging manifolds.

10. The system of claim 7, wherein the separator comprises an air channel for air to pass therethrough.

11. The system of claim 10, wherein the side surface of the separator comprises an opening in fluid communication with the air channel, and wherein the coating does not substantially block the opening.

12. The system of claim 10, further comprising an air manifold placed over at least a portion of the aggregated surface comprising the opening.

13. The system of claim 12, wherein the coating is not formed on the portion of the aggregated surface over which the air manifold is placed.

14. The system of claim 12, wherein the coating covers at least a portion of an exterior surface of the air manifold.

15. The system of claim 6, wherein the interfacial lines are formed between the MEA and the gasket, or between the gasket and the separator.

16. The system of claim 15, wherein the coating covers a portion of the side surface of MEA and the separator.

17. The system of claim 16, wherein the coating covers a portion of the side surface of MEA, the gasket and the separator.

18. The system of claim 4, wherein the separator comprises a coolant channel for a liquid coolant to pass therethrough.

19. The system claim 18, wherein the end plates comprises a coolant supplying pipe and a coolant discharging pipe, wherein the unit cell assembly comprises a coolant supplying manifold and a coolant discharging manifold, which are connected to the coolant supplying and discharging pipes, and wherein the coolant channel is connected to the coolant supplying and discharging manifolds.

20. The system of claim 4, wherein the separator comprises an air channel for air to pass therethrough.

21. The system of claim 20, wherein the side surface of the separator comprises an opening in fluid communication with the air channel, and wherein the coating does not substantially block the opening.

22. The system of claim 20, further comprising an air manifold placed over at least a portion of the aggregated surface comprising the opening.

23. The system of claim 22, wherein the coating is not formed on the portion of the aggregated surface over which the air manifold is placed.

24. The system of claim 22, wherein the coating covers at least a portion of an exterior surface of the air manifold.

25. The system of claim 1, wherein the coating extends substantially throughout the aggregated surface covering most of the interfacial lines formed on the aggregated surface.

26. The system of claim 1, wherein the coating contacts the end plates.

27. The system of claim 1, wherein each plate-like structure comprises a second edge and a second side surface extending from the second edge, the second side surfaces of the plate-like structures forming a second aggregated surface, which comprises a plurality of second interfacial lines, each of which is formed by the second edges of two contacting plate-like structures.

28. A method of making a fuel cell system comprising a fuel cell stack, the method comprising:
providing a unit cell assembly comprising a plurality of plate-like structures stacked between two end plates, each plate-like structure comprising an edge and a side surface extending from the edge, the side surfaces of the plate-like structures forming an aggregated surface, which comprises a plurality of interfacial lines, each interfacial line being formed by the edges of two contacting plate-like structures; and
coating over at least a portion of the aggregated surface to cover at least a portion of the interfacial lines.

29. The method of claim 28, wherein coating comprises:
providing a mold comprising a cavity;
placing the unit cell assembly into the cavity;
supplying a liquid coating material into the cavity such that the liquid coating material contacts the unit sell assembly;
solidifying the coating material within the cavity; and
removing the mold.

30. The method of claim 29, wherein the coating material comprises at least one of a polyamid resin, a polyolefin resin, acrylic resin, epoxy resin, and acrylonitrile butadiene styrene copolymer resin.

31. The method of claim 28, wherein the plate-like structures comprises at least one unit cell comprising a membrane electrolyte assembly (MEA) and a pair of separators.

32. The method of claim 31, wherein the plate-like structures further comprises a gasket placed between the MEA and the separator.

33. The method of claim 28, wherein coating comprises spraying a coating material over at least a portion of the aggregated surface.
